(19) United States
(12) Patent Application Publication
(10) Pub. No.: US 2008/0014990 A1
(43) Pub. Date: Jan. 17, 2008

(54) METHOD OF LOCATING A MOBILE COMMUNICATION SYSTEM FOR PROVIDING ANTI THEFT AND DATA PROTECTION DURING SUCCESSIVE BOOT-UP PROCEDURE

(75) Inventors: Anku Jain, Gurgoan (IN); Amit Kumar, Meerut (IN); Guan-Hua Tu, Taipei City (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: PIXTEL MEDIA TECHNOLOGY (P) LTD., Noida (U.P.) (IN)

(21) Appl. No.: 11/772,322

(22) Filed: Jul. 2, 2007

Related U.S. Application Data
(63) Continuation-in-part of application No. 11/189,151, filed on Jul. 25, 2005.

(30) Foreign Application Priority Data
Aug. 18, 2006 (IN) 1849/DEL/2006

(51) Int. Cl. H04M 1/66

(52) U.S. Cl. 455/558; 455/410

(57) ABSTRACT

A mobile communication system is provided, comprising a communication device, a subscriber identity module (SIM) comprising a first SIM card, and a controller. The controller transmits an apparatus loss acknowledgement message to a receiver via the communication device. The apparatus loss acknowledgement message comprises information indicating that the mobile communication system is present in a location, or indicating that a subscriber telephone number is employed in the mobile communication system, when detecting that a second SIM card has removed from and the first SIM card has inserted in the SIM module of the mobile communication system.

### CROSS REFERENCE TO RELATED APPLICATIONS

This is a continuation-in-part application of copending application Ser. No. 11/189,151 filed 2005 Jul. 25. In addition, this application claims priority of India Provisional Patent Application Ser. No. 1849/DEL/2006, filed 2006 Aug. 18.

### BACKGROUND

The invention relates to a mobile communication system and more particularly focus on providing anti-theft or data protection during a successive boot up procedure after configuration, as well as, focus on configuring settings for anti-theft or data protection in idle interface.

This invention relates to a mechanism of configuring and locating the mobile communication system when a SIM card installed therein is replaced with another SIM card.

With continuous developments in mobile technology, mobile phone loss can incur considerable expense and inconvenience.

Mobile phones are generally identified by a unique international mobile equipment identity (IMEI). When the mobile phone is lost, the location thereof can be traced via an IMEI-trace procedure provided by a TSP (Telecommunication service provider). However, if a SIM (Subscriber identity module) card originally installed in the mobile phone is replaced, the TSP corresponding to the original SIM card cannot trace the mobile phone via the IMEI-trace procedure. It is possible to locate the mobile phone by requiring many TSPs to perform the IMEI-trace procedure, but only at considerable expense. In addition, if the mobile phone is transported to another country, it is impossible to locate.

Mobile phones incorporating GPS (global position system) capability are expensive and not readily available.

Some conventional mobile phones implement a security function. For example, each SIM card has a PIN (personal identity number) as a password, and each mobile phone has several kinds of security codes for preventing the mobile phone from being misused and/or preventing important information stored therein from being accessed. However, the conventional security function is not capable of locating the mobile phone.

Hence, a system and method is needed for locating a mobile communication system when a SIM card installed therein is replaced with another SIM card.

### SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

An embodiment of a mobile communication system is provided, comprising a communication device, a subscriber identity module (SIM) comprising a first SIM card, and a controller. The controller transmits an apparatus loss acknowledgement message to a receiver via the communication device. The apparatus loss acknowledgement message comprises information indicating that the mobile communication system is present in a location, or indicating that a subscriber telephone number is employed in the mobile communication system, when detecting that a second SIM card has removed from and the first SIM card has inserted in the SIM module of the mobile communication system.

Another embodiment of a mobile communication system is provided, comprising a storage device storing a file, a SIM comprising a first SIM card, and a controller. The controller hides or deletes the file when detecting that a second SIM card has removed from and the first SIM card has inserted in the SIM module of the mobile communication system.

Still another embodiment of a mobile communication system is provided, comprising a SIM unit comprising a SIM card, and a controller. The controller provides a idle interface, acquires a password string from the idle interface, and turns on an acknowledgement option after validating the password string. When the acknowledgement option is turned on and the SIM card is replaced with another SIM card, an apparatus loss acknowledgement message comprising information indicating that the mobile communication system is present in a location, or indicating a subscriber telephone number is currently employed in the mobile communication system will be transmitted to a receiver, or a file stored in the mobile communication system will be hidden or deleted during a successive boot up procedure.

### DESCRIPTION OF THE DRAWINGS

The invention can be more fully understood by reading the subsequent detailed description and examples with references made to the accompanying drawings, wherein:

FIG. 1 is a block diagram of an embodiment of a mobile communication system.

FIG. 2 is a block diagram illustrating the mobile communication system of FIG. 1 when an original SIM card is replaced with a second SIM card.

FIG. 3 illustrates a flowchart of an embodiment of a method for configuring the settings for a device location application and a data security application.

FIG. 4 illustrates a flowchart of an embodiment of a method for locating a mobile communication system and protecting private information stored therein.

### DETAILED DESCRIPTION

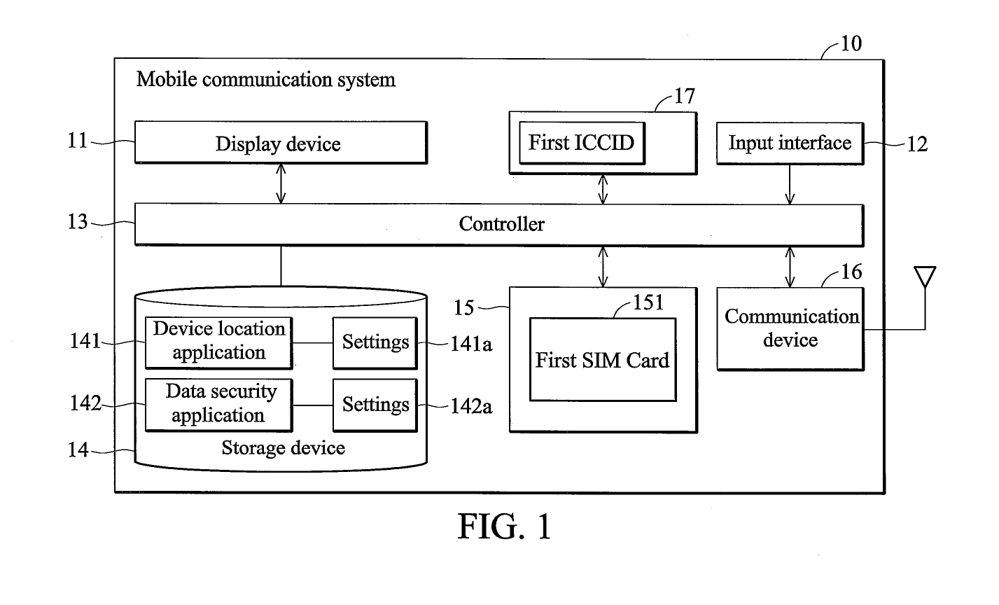

The invention is now described with reference to FIGS. 1 through 4, which generally relate to mobile communication. In the following detailed description, reference is made to the accompanying drawings which form a part thereof, and in which are shown by way of illustration specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures corresponds to the Figure number, with the exception that the same reference number is used throughout to refer to an identical component which appears in multiple figures. It should be understood that the many of the elements described and illustrated throughout the specification are functional in nature and may be embodied in one or more physical entities or may take other forms beyond those described or depicted.

FIG. 1 is a block diagram of an embodiment of a mobile communication system 10 comprising a display device 11, an input interface 12, a controller 13, a storage device 14, a Subscriber Identity Module (SIM) module 15, a communication device 16, and secured memory 17.

The mobile communication system 10 can be a mobile phone or other portable device.

The display device 11 comprises a liquid crystal display (LCD), displaying information for the mobile communication system 10. When the controller 13 performs no tasks in response to user operation, such as traversing UI menu, browsing short messages, playing MP3, making phone calls, or others, an idle interface is provided.

The input interface 12 can be a keyboard, enabling input of information such as settings for device location application 141 and data security application 142, into the mobile communication system 10.

Here, a SIM card 151 is inserted in the SIM module 15 and coupled with the mobile communication system 10 thereby. The SIM card 151 stores the information identifying a mobile phone service subscriber, as well as subscription information, saved telephone numbers, and other information. In addition, the SIM card 151 stores network state information such as current location area identity (LAI). The LAI uniquely identifies a location area within any well-known Public Land Mobile Network (PLMN). The LAI is an internationally unique identifier typically comprises mobile country code (MCC), mobile network code (MNC) and location area code (LAC). The LAI is broadcast regularly by Broadcast Control Channel (BCCH). The controller 13 repeatedly receives the broadcast LAI representing the current location via the communication device 16 and stores the acquired LAI in the SIM card 151, the secured memory 17, or the storage device 14. If the mobile communication system 10 is turned off and powered on again, the stored LAI is retrieved from the SIM card 151, the secured memory 17, or the storage device 14. The SIM card 151 is uniquely identified by an ICCID (International Circuit Card ID). The ICCID may comprise 19 or 20-digit serial number, and can be acquired from a well-known elementary file of a SIM card.

The secured memory 17 stores a ICCID 171 being the same as that of the SIM card 151. The ICCID 171 is to be accessed by the device location application 141 when executed. The storage device 14 stores codes of applications installed in the mobile communication system 10. A device location application 141 and a data security application 142 are installed in the mobile communication system 10. Setting configuration for the device location application 141 and data security application 142 are accessed only when an idle interface is provided. A predefined user interface (UI) menu does not comprise menu items or visible icons corresponding to the device location application 141 and data security application 142. Thus, user can not activate the device location application 141 and data security application 142 by manipulating the UI menu.

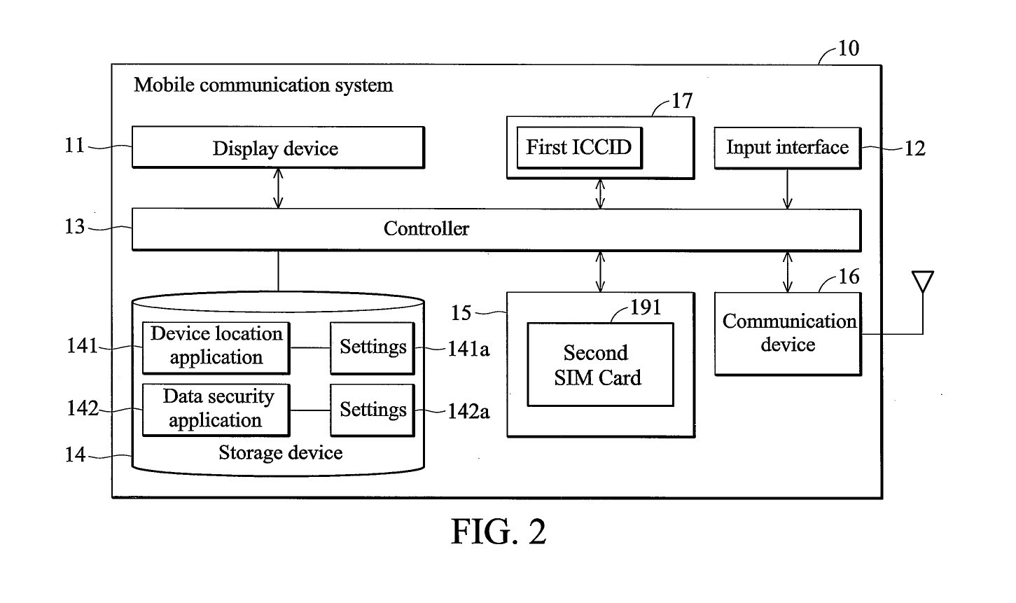

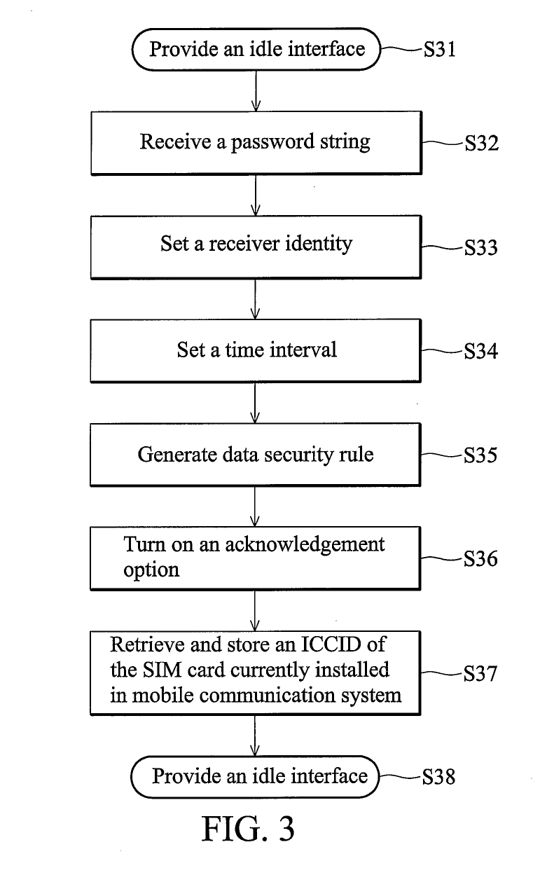

FIG. 3 illustrates a flowchart of an embodiment of a method for configuring the settings for a device location application and a data security application, performed by a controller. The method of FIG. 3 can be implemented in the systems of FIG. 1 and FIG. 2, which comprise pre-installed device location application 141 and data security application 142. FIG. 3 illustrates a procedure of initiating the pre-installed device location application 141 and data security application 142.

In step S31, an idle interface is provided.

In step S32, a password string is received via the idle interface to initiate configuration of settings for the device location application 141 and/or data security application 142. The password string may be a supplementary service control (SSC) string, for example, “*#1234#”. It is to be understood that the initiation of settings for the device location application 141 and data security application 142 can not be performed via a UI event of a menu item or visible icon of a predefined UI menu, and can be performed only after successfully validating the input password string acquired from the idle interface. Moreover, the configuration initiation of settings for the device location application 141 and data security application 142 can not be performed when receiving a wrong password string.

In step S33, a receiver identity is set for the device location application 141, wherein the receiver of the acknowledgement message can be specified as a phone number or e-mail address. The receiver is set according to information input by a user, and can be stored in the storage device 14 as one of settings 141a.

In step S34, time interval is set for the device location application 141, wherein the time interval may specify a transmission instant for an apparatus loss acknowledgement. For example, the device location application 141 may periodically transmit the apparatus loss acknowledgement message to a receiver with the set receiver identity after the set time interval has elapsed from the last transmission of the apparatus loss acknowledgement message. The time interval is set according to information input by a user, and can be stored in the storage device 14 as one of the settings 141a.

In step S35, data security rules are generated, indicating that particular data and/or file, such as phone book, received short messages, pictures, or others, are hidden or are deleted when activating the data security application 142. The data security rules are generated according to information input by a user, and can be stored in the storage device 14 as some of the settings 142a.

In step S36, an acknowledgement option is turned on. The acknowledgement option is set according to information input by a user, and can be stored in the storage device 14 as some of the settings 141a and 142a.

In step S37, an ICCID of the SIM card currently installed in the SIM module 15 is retrieved and stored when the acknowledgement option is turned on. The ICCID of the SIM card may be retrieved from the well-known elementary files of the SIM card. Here, the SIM card currently installed in the mobile communication system 10 is referred to as the first SIM card 151, and the ICCID corresponding thereto is a first ICCID. The first ICCID is stored in the secured memory 17 in order to prevent modification of the stored ICCID. It is to be understood that the secured memory 17 is non-volatile memory. In some embodiments, the first ICCID may be stored in secured storage space of the storage device 14 in order to prevent modification of the stored ICCID.

In step S38, an idle interface is provided after completing configuration for device location application 141 and data security application 142.

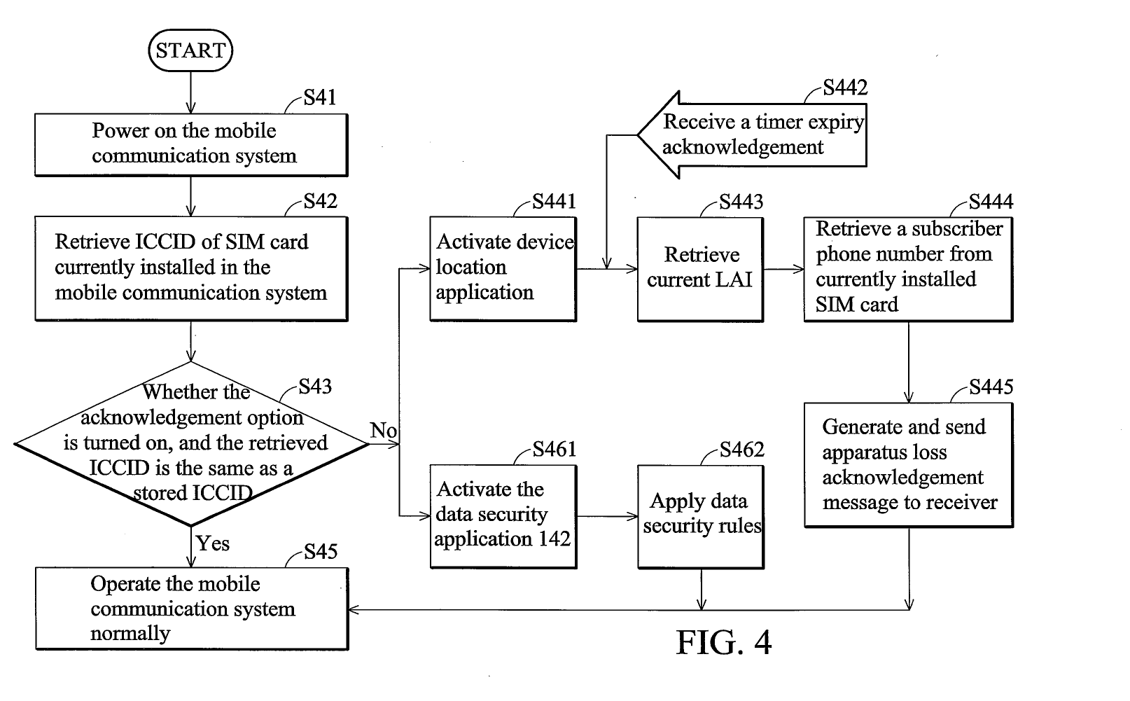

FIG. 4 illustrates a flowchart of an embodiment of a method for locating of the mobile communication system 10 and protecting information stored therein from been theft during a boot up procedure.

When the acknowledgement option is turned on, it is determined whether the original SIM card (the first SIM card as shown in FIG. 1) is replaced with another SIM card (the second SIM card as shown in FIG. 2) to determine whether to activate the device location application 141 and data security application 142. The detection is performed during a boot up procedure after the mobile communication system 10 is powered on. The boot up procedure may further load and start an operating system of the mobile communication system 10.

In step S41, the mobile communication system 10 is powered on.

In step S42, a ICCID of a SIM card currently installed in the mobile communication system 10 is retrieved, such as a first ICCID of the first SIM card 151 as shown in FIG. 1, or a second ICCID of the second SIM card 191 as shown in FIG. 2.

In step S43, it is determined whether the acknowledgement option is turned on, and the retrieved ICCID is the same as the stored ICCID of the secured memory 17, and if so, the method proceeds to step S45, otherwise, to steps S441 and S461.

In step S45, the mobile communication system 10 operates normally, and device location application 141 and data security application 142 are not activated.

In step S441, the device location application 141 is activated. In step S442, a timer expiry acknowledgement is received from a timer, wherein the timer is set according to the time interval specified in the settings 141a. In step S443, a LAI indicating the current location is retrieved from a SIM card (e.g. 191 of FIG. 2), secured memory (e.g. 17 of FIG. 2), or a storage device (e.g. 14 of FIG. 2). In step S444, a subscriber phone number, also called a mobile subscriber integrated services digital network (MSISDN) number, is retrieved from the installed SIM card, such as the second SIM card 191 of FIG. 2. In step S445, an apparatus loss acknowledgement message is generated and sent to a receiver with the set receiver identity according to the preset settings, such as 141a of FIG. 2. The apparatus loss acknowledgement message comprises information indicating that the mobile communication system 10 is present in a location identified by the LAI. The apparatus loss acknowledgement message may comprise information indicating which subscriber telephone number is currently employed in the mobile communication system 10.

It is to be understood that, no logs regarding the transmissions of acknowledgement message are recorded by the controller 13 in order to prevent such acknowledgement messages are recognized via browsing logs of a well-known out message box.

In step S461, the data security application 142 is activated. In step S462, the preset data security rules is applied on relevant data and/or files stored in the storage device 14 according to the preset settings, such as 142a of FIG. 2, to hide or delete the applied data and/or files.

The invention enables the user to get information about lost or stolen mobile apparatus in a confidential manner, while protecting information from accessed by unauthorized user.

The original user can enable and disable the device location application 141 and data security application 142 by turning on or off the described acknowledgement.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mobile communication system, comprising:
a communication device;
a subscriber identity module (SIM) comprising a first SIM card; and
a controller transmitting an apparatus loss acknowledgement message to a receiver via the communication device, comprising information indicating that the mobile communication system is present in a location, or indicating that a subscriber telephone number is employed in the mobile communication system, when detecting that a second SIM card has removed from and the first SIM card has inserted in the SIM module of the mobile communication system during a boot up procedure.

2. The mobile communication system of claim 1, wherein the location is identified by a location area identity (LAI), the LAI is an internationally unique ID, and the controller receives the broadcast LAI by a broadcast control channel (BCCH).

3. The mobile communication system of claim 1, wherein the controller acquires the subscriber telephone number from the first SIM card.

4. The mobile communication system of claim 1, wherein the boot up procedure loads and starts an operating system of the mobile communication system.

5. The mobile communication system of claim 1, wherein the apparatus loss acknowledgement message is transmitted after receiving a timer expiry acknowledgement from the last transmission of an apparatus loss acknowledgement message.

6. The mobile communication system of claim 1, wherein the detection of removal of the second SIM card is achieved by detecting whether a first international circuit card ID (ICCID) of the first SIM card is the same as a second ICCID of the second SIM card.

7. The mobile communication system of claim 6, wherein the second ICCID is stored in secured storage space of the mobile communication system.

8. The mobile communication system of claim 1, wherein the controller records no logs regarding the transmission of the apparatus loss acknowledgement message.

9. A mobile communication system, comprising:
a storage device storing a file;
a subscriber identity module (SIM) comprising a first SIM card; and
a controller hiding or deleting the file when detecting that a second SIM card has removed from and the first SIM card has inserted in the SIM module of the mobile communication system during a boot up procedure.

10. The mobile communication system of claim 9, wherein the boot up procedure loads and starts an operating system of the mobile communication system.

11. The mobile communication system of claim 9, wherein the detection of removal of the second SIM card is achieved by detecting whether a first international circuit card ID (ICCID) of the first SIM card is the same as a second ICCID of the second SIM card.

12. A mobile communication system, comprising:
a subscriber identity module (SIM) comprising a SIM card; and
a controller providing a idle interface, acquiring a password string from the idle interface, turning on an acknowledgement option after validating the password string,
wherein, when the acknowledgement option is turned on and the SIM card is replaced with another SIM card, an apparatus loss acknowledgement message comprising information indicating that the mobile communication system is present in a location, or indicating a subscriber telephone number is currently employed in the mobile communication system will be transmitted to a receiver, or a file stored in the mobile communication system will be hidden or deleted during a successive boot up procedure.

13. The mobile communication system of claim 12, wherein the password string is a supplementary service control string.

14. The mobile communication system of claim 12, wherein the controller sets a receiver identity of the receiver.

15. The mobile communication system of claim 12, wherein the controller generates a data security rule indicating that the file will be hidden or deleted when the acknowledgement option is turned on and the SIM card is replaced with another SIM card.

16. The mobile communication system of claim 12, wherein the controller stores an international circuit card ID (ICCID) in secured storage space when turning on the acknowledgement option.

17. The mobile communication system of claim 16, wherein that the SIM card is replaced with another SIM card is detected by determining that the stored ICCID is different from an ICCID of a current employed SIM card.

18. The mobile communication system of claim 12, wherein the successive boot up procedure is performed after the mobile communication system is turned off and powered on again.
